(19) United States
(12) Patent Application Publication
(10) Pub. No.: US 2008/0022402 A1
(43) Pub. Date: Jan. 24, 2008

(54) Method of detecting that a unit is sending a large number of frames over a network

(75) Inventors: Stanislas Francfort, Evrecy (FR); Laurent Butti, Issy Les Moulineaux (FR); Franck Veysset, Issy Les Moulineaux (FR)

Correspondence Address: COHEN PONTANI LIEBERMAN & PAVANE LLP, Suite 1210, 551 Fifth Avenue, New York, NY, 10176, US

(73) Assignee: France Telecom, Paris (FR)

(21) Appl. No.: 11/879,863

(22) Filed: Jul. 18, 2007

(30) Foreign Application Priority Data
Jul. 18, 2006 (FR) 06/53021

(51) Int. Cl. G06F 9/48

(52) U.S. Cl. 726/22

(57) ABSTRACT

A method of detecting that a unit communicating with a communications network is sending a large number of frames over that network, said method including a step of analyzing a distribution of the time shifts between frames sent over the network in order to determine if said distribution corresponds to a distribution with memory.

### FIELD OF THE INVENTION

The present invention relates to the field of communications networks and in particular to detecting that a unit is sending a large number of frames. More specifically, the invention detects flooding type denial-of-service attacks made on a network by data pirates.

### BACKGROUND OF THE INVENTION

Flooding type denial-of-service attacks are characterized by sending a large number of malformed or non-standard frames, for example. This can disrupt the operation of means for recognizing all kinds of attack made on the network and signaling them by means of alarms. It also makes processing these alarms more difficult.

If a malicious user floods the network with malformed or non-standard frames, the means for recognizing and signaling attacks associate an alarm with each malformed or non-standard frame. A large number of alarms is therefore stored in a database, which disrupts the use of this information by an administrator responsible for network surveillance.

To protect the database from too great a number of alarms, some or all alarms can be grouped together. Alarms are grouped if the means for recognizing and signaling attacks receive a large number of frames, exceeding a particular threshold. For this purpose, alarms linked to frames sent by the same malicious unit, in particular those having the same identification address, are grouped together. A given unit normally has only one identification address, which it writes into the frames that it sends.

It is nowadays possible to identify the identification address of a unit, as explained in the document “Detecting Wireless LAN MAC Address Spoofing” by J. Wright, which can be consulted at the address http://home.jwu.edu/jwright/papers/wlan-mac-spoof.pdf. This is why alarms cannot be grouped correctly in the event of a flooding type denial of service attack. The pirate modifies the identification address of the sending before the number of frames sent exceeds the threshold, beyond which one alarm represents multiple alarms. Consequently, the information is more difficult to use, the database again being flooded with alarms.

### OBJECTS AND SUMMARY OF THE INVENTION

One object of the present invention is to alleviate or at least reduce some or all of the problems mentioned above by detecting that the same unit is sending a large number of frames, more particularly when the unit is sending a large number of frames using more than one identification address to send them.

This and other objects are attained in accordance with one aspect of the present invention directed to a method of detecting that a unit communicating with a communications network is sending a large number of frames over that network, including a step of analyzing a distribution of the time shifts (Δi) between frames (Tri, Tri+1) sent over the network in order to determine if said distribution corresponds to a distribution with memory.

Thus detecting that a unit is sending a large number of frames is more effective. The temporal link between frames coming from the same unit is more difficult to modify than an identification address.

Non-limiting preferred embodiments of the method of the invention have the following additional features, separately or in combination:

The time shifts correspond to the reception time difference between frames sent over the network.

The analysis is therefore based on temporal values that are easy to determine.

The time shifts correspond to the temporal label differences between frames sent over the network.

This circumvents any time shifts that may occur when the frames pass through the transmission medium.

According to a second aspect of the invention, a device for detecting that a unit communicating with a communications network is sending a large number of frames comprises:

means for receiving frames sent over the network; and

means for analyzing a distribution of the time shifts (Δi) between frames (Tri, Tri+1) sent over the network in order to determine if said distribution corresponds to a distribution with memory.

A third aspect of the invention is directed to a computer program on a data medium and adapted to be loaded into the internal memory of a computer, the program comprising code portions for executing steps of a method of detecting that a unit is sending a large number of frames when the program is executed on said computer.

According to a fourth aspect of the invention, a programmable component containing a program comprises code portions for executing steps of a method of detecting that a unit is sending a large number of frames when the component executes said program.

A fifth aspect of the invention is directed to a method of detecting attacks in a communications network including a step of analyzing a distribution of the time shifts (Δi) between frames (Tri, Tri+1) sent over the network, in order to determine if said distribution corresponds to a distribution with memory.

A sixth aspect of the invention is directed to a computer program on a data medium and adapted to be loaded into the internal memory of a computer, said program comprising code portions for executing steps of a method of detecting attacks in a communications network when the program is executed on said computer.

### BRIEF DESCRIPTION OF THE DRAWINGS

FIG. 1 is a diagram of a device of the invention for detecting that a unit is sending a large number of frames;

FIG. 2 shows a first embodiment of a device of the invention for detecting attacks;

FIG. 3 shows a second embodiment of a device of the invention for detecting attacks;

FIG. 4 shows a third embodiment of a device of the invention for detecting attacks; and

FIG. 5 is a flowchart of a method used by the device of the invention.

### DETAILED DESCRIPTION OF THE DRAWINGS

The invention is described below in one particular application to detecting denial of service attacks. This detection function can be incorporated into a device for detecting some or all attacks on a communications network.

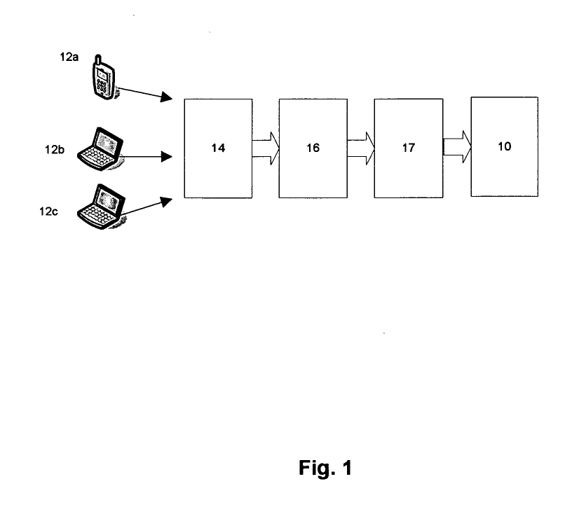

FIG. 1 is a diagram of a device of the invention for detecting that a unit is sending a large number of frames.

Units 12a, 12b, 12c communicate with a communications network. They can be fixed or mobile computers or any other communicating terminal. The network can be of any type. Thus it can be a cable network such as the Internet or an Ethernet network. Alternatively, it can be a wireless network, such as a Wi-Max or Wi-Fi network. This type of network is currently widely used in hot-spot, business and domestic networks.

The units 12a, 12b, 12c communicate by sending frames over the network. Here the term “frame” refers to a set of data forming a block transmitted in the network and containing payload data and service information. Depending on the context, frames may consist of data packets, datagrams, blocks of data, and the like.

Frames sent by the units 12a, 12b, 12c are received by means 14 provided for receiving them. The means 14 comprise a probe for monitoring the network, for example. Monitoring refers to the fact that the probes copy at least some of the frames sent over the network into a table or buffer. Alternatively, the means 14 can comprise a central collector connected to a plurality of probes. This variant enables a network, in particular a wireless network, to be monitored at different locations and the processing of frames thereafter to be centralized. The probes can be independent structures or software forming part of another structure. Also, a probe can be divided between a plurality of structures.

The monitored frames are then forwarded to frame selection means 16 that select at least some of the frames received and forward them to temporal correlation analysis means having the function of determining whether there is a temporal link between at least some of the frames received by the means 14. During a flooding type denial of service attack, the unit controlled by the data pirate sends a large number of frames, meaning a number exceeding what a non-malicious unit sends when it is communicating normally with the network. When a unit sends frames, they are temporally linked for physical reasons. Frames are generated by a sequential loop clocked by the basic clock of the unit. Frames are therefore sent periodically, and there is therefore a strong temporal link between frames, even if the data sent is not logically linked. By exploiting this characteristic, it is possible to analyze the temporal correlation between at least some of the received frames. Note that there is no temporal link between frames sent by different units, as their basic clocks are not synchronized. The correlation analysis means can therefore be structures in their own right or software. The means 17 can be combined with one or more probes in the same structure or divided between a plurality of structures.

The temporal correlation analysis means 17 then send information to means 10 for recognizing and signaling any kind of attack. The means 10 can be intrusion detection systems (IDS) or intrusion prevention systems (IPS), for example. An intrusion detection system (IDS) is a set of software and/or hardware components having as its main function recognizing and signaling any intrusion attempt. An intrusion prevention system (IPS) generally has the functions of an IDS plus prevention and network protection functions. The information forwarded by the means 17 can either be an alarm signaling a denial of service attack or signal that a particular frame sample that has been analyzed is suspect, i.e. that they might have the potential to found a flooding type denial of service attack.

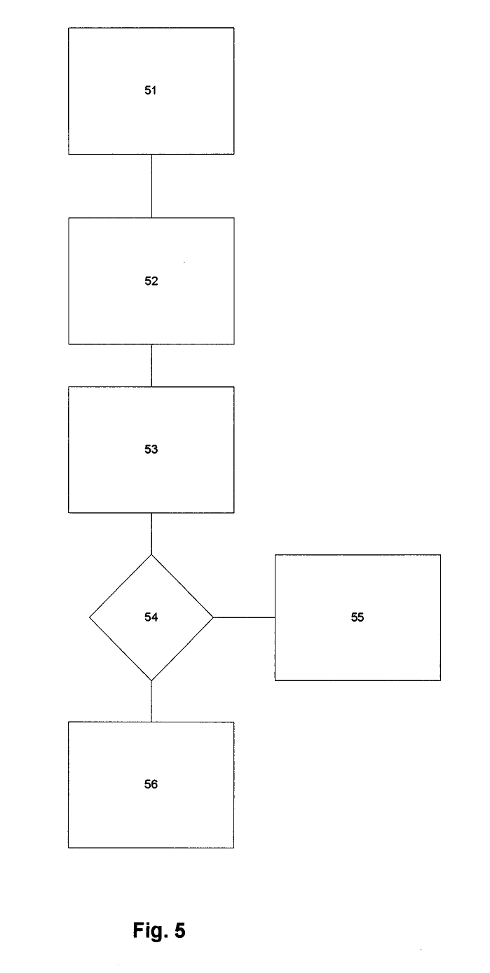

A method of detecting that a unit is sending a large number of frames over the network is described in more detail next with reference to FIG. 5.

When a unit, for example the unit 12a, sends a large number of frames, the means 14 monitor them in the step 51. The means 14 associate with each received frame Tr, Tr+1 a receive time ti, ti+1, for example a number of milliseconds. The frames to be analyzed are then selected in the step 52 and are then available to the temporal correlation analysis means 17 in the step 53.

A first method of determining the existence of a link between frames determines if there is any temporal autocorrelation between them. To this end, the receive time of the frames is analyzed over a given period and the means 17 send an alarm if it is determined that a profile representing a plurality of frame arrival times is repeated.

A second method analyzes whether a distribution of variables X, characteristic of the frames, is a distribution without memory or not, i.e. if the arrival time of a frame is linked to the arrival time of a preceding frame. A distribution of variables X corresponds to a distribution without memory if and only if, whatever the positive values “s” and “t”, the probability that [X>t+s knowing that x>t] is equal to the probability that [X>s]. This amounts to determining if the distribution of the variables X conforms to the Levy process, for example.

Alternatively, this amounts to determining if the distribution of the variables X satisfies Poisson's distribution law.

The process is therefore robust, as it allows some margin for error in analyzing the temporal correlation between frames. Accordingly, even if frames sent by the units suffer certain time delays, or even if some frames are lost, the analysis of temporal correlation between frames remains reliable. Note that time delays can be caused by the physical medium constituting the network.

If, in the step 52, the selection means 16 select all the received frames, the variable X can be the time shift Δi between the times of arrival of the frames received by the means 14. This time shift Δi therefore corresponds to the difference between the receive times ti and ti+1 of two frames Tri and Tri+1 successively received by the means 14.

If, in the step 52, the selection means 16 select some of the received frames, the variable X can be the time shift Δi corresponding to the difference between the receive times ti and ti+1 of two frames Tri and Tri+1 successively selected by the frame selection means 16.

The task of the means 17 is then to analyze if the temporal distribution of the time shifts Δi between the selected frames Tri, Tri+1 sent over the network corresponds to a distribution with memory or not. This amounts to determining if the distribution of the time shifts Δi satisfies Poisson's distribution law, for example.

Let D={x1; x2; . . . ; xn} denote the experimental distribution of the time shifts Δi, n being the number of frames processed by the correlator. The number n can be of the order of 10000, for example. The correlation analysis means 17 initially classify the sample D into equivalence classes Xj (j varying for 1 to k). Each equivalence class corresponds to a time interval of fixed duration, for example 1 millisecond. Each class Xj is associated with the number nj of xi that are equal to each other.

For example, the following absolute frequencies were obtained from a sample of size n=10000 for the 11 integer values of a random variable X:

| X | nj |
|---|---|
| 0 | 166 |
| 1 | 895 |
| 2 | 1640 |
| 3 | 2058 |
| 4 | 1925 |
| 5 | 1478 |
| 6 | 946 |
| 7 | 301 |
| 8 | 296 |
| 9 | 198 |
| 10 | 97 |

The correlation analysis means 17 then analyze whether the distribution of the random variable X follows a distribution with or without memory. Poisson's distribution law can be used for this. Thus the mean of the samples is calculated.

Let:
L1:=[0, 1, 2, 3, 4, 5, 6, 7, 8, 9, 10
L2:=[166, 895, 1640, 2058, 1925, 1478, 946, 301, 296, 198, 97]
Mean (L1,L2)

There is obtained:

38342/10000

The means 17 then determine the shift

$$E = {\sum }_{j = 1}^{k 0} \frac{{( Xj - ej )}^{2}}{ej} ,$$

ej corresponding to the theoreticl absolute frequency determined using the formula:

$$ej = n * {e}^{- M} \frac{{M}^{j}}{j !} ;$$

for j varying from 1 to k.

According, in this example, the theoretical absolute frequencies are:
10000*poisson (3.8342, 0), 10000*poisson (3.8342, 1), etc.
10000*poisson (3.8342, 9), 10000*poisson (3.8342, 10).

With poisson (3.8342, k)=exp(−3.8342)*(3.8342ˆk)/k!

There is obtained the list L of the 11 values ej for j=0 . . . 10.
[216.1862645522, 828.9013755462, 1589.0868270596, 2030.9589041040, 1946.7756575289, 1492.8654452194, 953.9907816767, 522.5416364436, 250.4411428065, 106.6934921943, 40.9084187771]

The value of the last class is changed in order to have all the values not taken into account by the preceding ej (the sum of the ej must be equal to 10000).

The list L of the ej is thus obtained:
[216.1862645522, 828.9013755462, 1589.0868270596, 2030.9589041040, 1946.7756575289, 1492.8654452194, 953.9907816767, 522.5416364436, 250.4411428065, 106.6934921943, 61.55847286854987]

The correlator then groups the ej by summing adjacent ej so that there remain only classes of value greater than or equal to 10000*S. S is the threshold for rejection of the observed distribution because it does not satisfy Poisson's distribution law (for example S=0.01 or S=0.05).

The list L of the theoretical absolute frequencies ej is thus obtained with ej>500, for example:

[1045.087640098437, 1589.0868270596, 2030.9589041040, 1946.7756575289, 1492.8654452194, 953.9907816767, 941.2347443128931]

In the same way the correlator groups the Xj by adding the values for which the ej have been added, j now varying from 1 to k0 for the Xj, as for the ej. The list L2 of empirical absolute frequencies corresponding to these seven classes is:

L2:=[1061, 1640, 2058, 1925, 1478, 946, 892]

It is now possible for the correlator to calculate the shift E according to the formula given, thus obtaining E=5.26747031564484.

In the step 54, the correlator compares the shift E with a parameter h satisfying the equation:
Prob(χₖ₋₂²>h)=1−S

To determine h, tables are used giving h as a function of the degree of freedom (here 7−2=5) and the parameter S. In this example, h=11.07.

The step 55 corresponds to this example where E<h, so that the distribution is a distribution without memory, and it is deemed that there is no flooding type denial of service attack. The step 56 corresponds to the contrary situation where E>h, in which case the distribution is a distribution with memory and it is deemed that there is a potential attack.

Note that the device for detecting that a unit is sending a large number of frames works even if one or more units are effecting a flooding type denial of service attack and even if one or more non-malicious units are communicating with the network.

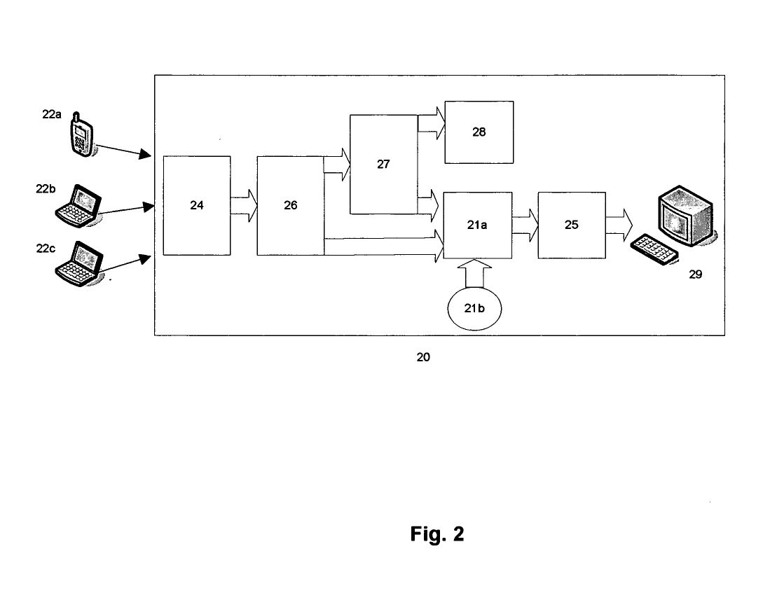

FIG. 2 gives an example in which the device for detecting that a unit is sending a large number of frames is included in a more general attack detector device 20.

Here the term “attack” encompasses all possible types of attack on a network, namely passive attacks (for example recovery of the content of a message, analysis of traffic, etc.) and active attacks (for example replay attacks, denial of service attacks, etc.).

Units 22a, 22b, 22c send frames over the network. The frames are received by means 24 adapted to receive frames. The frames are then selected by means 26 that forward the frames to be analyzed to the correlation analysis means 27. Selection can encompass all received frames or retain only frames having a new identification address. The identification address can be a MAC (medium access control) address or an IP (Internet Protocol) address, for example. By selecting frames having a new identification address, the means 27 can detect if this identification address modification is periodic. Address modification is particularly dependent on the basic clock of the pirate sending unit. Alternatively, selection can relate to a particular type of frame, such as BEACON frames, authentication frames or any other clearly identified type of frame that a data pirate might send in large numbers.

If the distribution of the time shifts Δi appears suspect to the means 27, the frames associated with those time shifts are directed to ancillary processing means 28. If the distribution of the time shift does not appear suspect, the associated frames are directed to means 21a, 21b for recognizing and signaling any type of attack. Those means can also receive the frames that are not selected by the means 26. They include comparison means 21a and knowledge bases 21b. The bases contain some or all of the signatures of possible attacks on a communications network. Thus by analyzing the bits present in the frames coming from the means 26 and 27, the comparison means 21a can, through comparison with the knowledge bases 21b, signal frames including suspect portions.

Each suspect frame is then associated with an alarm stored in an event log 25. The event log 25 is then processed by an administrator responsible for network security. That administrator can be a person analyzing the alarms via a monitor 29 or graphical user interface. Alternatively, the event log 25 can equally well be processed automatically without human intervention. The administrator is therefore able to track over time attacks in progress over the network.

The means 26, 27 therefore operate like a filter. They prevent alarms being sent over suspect frames potentially participating in a flooding type denial of service attack. Processing of the event log by an administrator, especially a person, is therefore more absolute frequency, the monitor 29 suffering less of an alarm overload. Moreover, by means of the invention, a critical attack buried in the noise created by the excessive number of frames will be easier to detect. Thus an attack detector device 20 can include all of the means 24, 26, 27, 28, 21a, 21b, 25, 29.

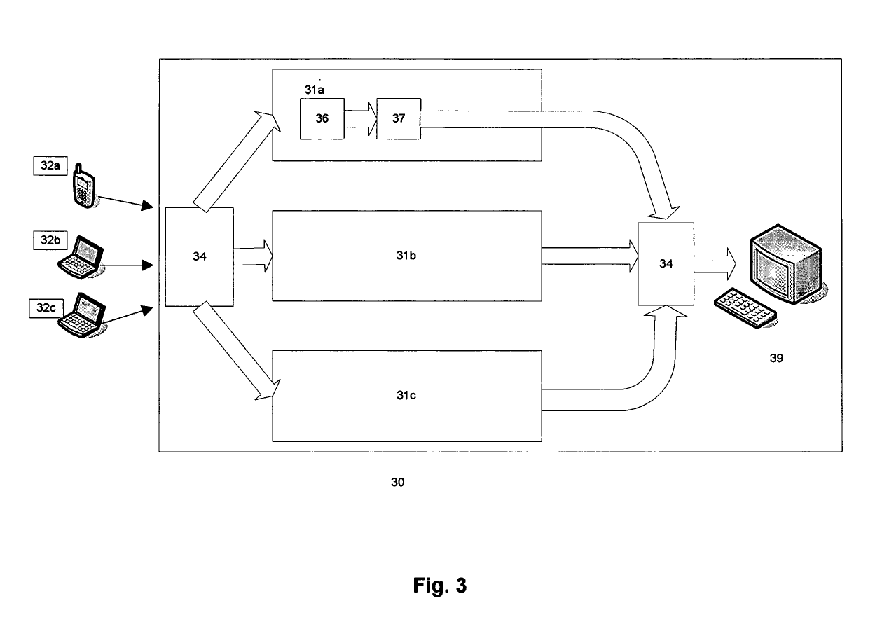

FIG. 3 shows a device for detecting that a unit is sending a large number of frames included in a more general attack detector device 30. This example differs from the previous one in particular in that the temporal correlation analysis means 37 are part of an attack search engine 31a that is part of the device 30, which includes other attack search engines 31b, 31c working in parallel on frames received by the means 34. Each engine sends alarms to an event log 35 processed by an administrator, for example via a monitor 39. Thus the engine 31a sends an alarm if it detects a flooding type denial of service attack. An attack detector device 30 can therefore include all of the means 34, 31a, 31b, 31c, 34, 39.

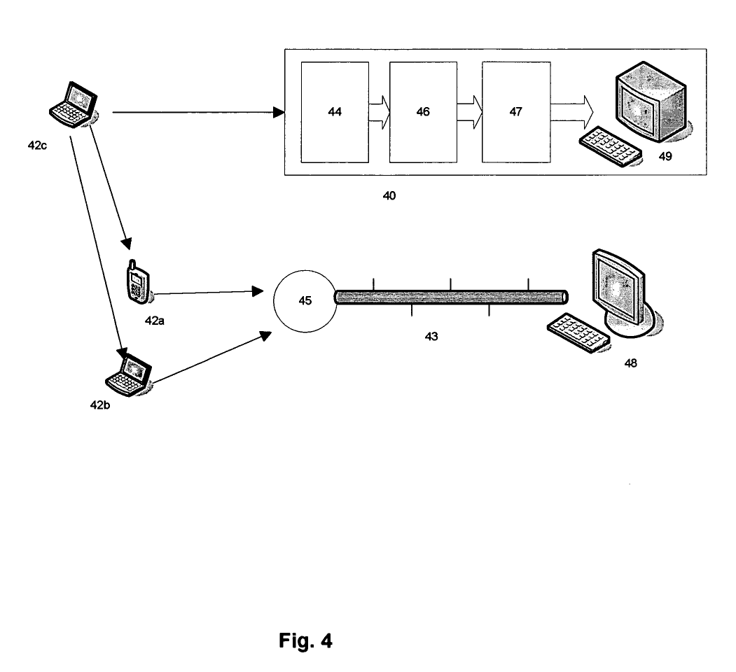

FIG. 4 shows a device for detecting that a unit is sending a large number of frames included in a more general attack detection device 40. In this example, a unit 42c of a data pirate usurps the identification address of an access point 45, communicating with various legitimate units 41a, 42b. The unit 42c can make a denial of service attack by “broadcasting”, i.e. by sending some frames, for example de-authentication frames or de-association frames, to all of the units 42a, 42b. These frames are encountered in particular in wireless networks. The units 42a, 42b are then disconnected from the access point 45, and therefore deprived of service, believing that request comes from that point 45. Note that the access point 45 is connected to a cable network 43, supervised by a server 48, for example.

Here data pirates act directly on the legitimate units. The massive sending of de-authentication or de-association frames thus prevents them from being reconnected to the access point 45.

A device 40 detects this attack using means 46 that select at least some of the frames received by the means 44. The means 46 select the de-authentication frames, for example. If the means 47 detect correlation between the selected frames, they send an alarm to an event log. That log is subsequently analyzed by a network administrator, for example via a monitor 49. The administrator can counter the attack by attempting to locate the malicious unit and physically neutralize it, for example. The administrator can equally warn the units 42, 42b to stop monitoring “broadcast” frames.

Thus the invention is particularly suitable for wireless networks. These networks are subjected to numerous attacks by data pirates. Certain frames sent over the network include a temporal label. This is an advantageous feature. The temporal label of a frame includes temporal information relating to the sending of the frame. Here this temporal information consists of the value of the basic clock of the sending unit that sent the frame at the time of sending the frame. The time shift Δi can therefore be the time difference between the temporal labels belonging to at least some of the frames Tri and Tri+1 received by the means 44. This circumvents time shifts that may occur when frames pass through the transmission medium. Frames including such temporal labels are BEACON or PROBE RESPONSE frames, for example.

The steps of the method of detecting that a unit is sending a large number of frames, and more generally the steps of the attack detection method, can be executed by a program loaded into a computer.

Alternatively, the steps of the method of detecting that a unit is sending a large number of frames, and more generally the steps of the attack detection method, can be executed by a program loaded into a programmable component.

The method of detecting that a unit is sending a large number of frames over a network has been described in its specific application to detecting attacks, more particularly to detecting flooding type denial of service attacks.

The method can be used for applications other than attack detection and can be used in all applications requiring determination that the same unit is sending a large number of frames.

I claim:

1. A method of detecting that a unit communicating with a communications network is sending a large number of frames over that network, wherein one step of said method analyzes a distribution of the time shifts between frames sent over the network in order to determine if said distribution corresponds to a distribution with memory.

2. The detection method according to claim 1, wherein the time shifts correspond to the reception time difference between frames sent over the network.

3. The detection method according to claim 1, wherein the time shifts correspond to the temporal label differences between frames sent over the network.

4. A device for implementing the method according to claim 1 to detect that a unit communicating with a communications network is sending a large number of frames, comprising:
means for receiving frames sent over the network; and
means for analyzing a distribution of the time shifts between frames sent over the network in order to determine if said distribution corresponds to a distribution with memory.

5. A computer program on a data medium and adapted to be loaded into the internal memory of a computer, the program comprising code portions for executing steps of the method according to claim 1 when the program is executed on said computer.

6. A programmable component containing a program comprising code portions for executing steps of the method according to claim 1 when the component executes said program.

7. A method of detecting attacks in a communications network, wherein one step of said method analyzes a distribution of the time shifts between frames sent over the network in order to determine if said distribution corresponds to a distribution with memory.

8. A computer program on a data medium and adapted to be loaded into the internal memory of a computer, the program comprising code portions for executing steps of the method according to claim 7 when the program is executed on said computer.
